(19) United States
(12) Patent Application Publication
(10) Pub. No.: US 2025/0276318 A1
(43) Pub. Date: Sep. 4, 2025

(54) Micro-optomechanical Sensor and Fabrication Method Thereof

(71) Applicant: IMEC VZW, Leuven (BE)

(72) Inventors: Hasan Md Mahmud-Ul, Leuven (BE); Simone Severi, Leuven (BE)

(21) Appl. No.: 19/065,823

(22) Filed: Feb. 27, 2025

(30) Foreign Application Priority Data
Mar. 1, 2024 (EP) 24160890.0

(51) Int. Cl. B01L 3/00

(52) U.S. Cl. CPC B01L 3/502761; B01L 3/502707; B01L 2200/0647; B01L 2200/12; B01L 2300/0654; B01L 2400/0433

(57) ABSTRACT

An example embodiment includes a micro-optomechanical sensor. The micro-optomechanical sensor includes a surface comprising a cavity, and a fluidic channel on the surface connected to the cavity. The fluidic channel is configured to transport a fluid sample to the cavity. The micro-optomechanical sensor also includes a cantilever on the surface being laterally extended inside the cavity. At least one side of the cantilever is configured to be in contact with the fluid sample inside the cavity. The micro-optomechanical sensor also includes an optical waveguide on the surface being extended to the cantilever. The optical waveguide is configured to couple out a light signal from the cantilever in order to optically transduce a mechanical vibration of the cantilever.

### CROSS-REFERENCE TO RELATED APPLICATIONS

The present application is a non-provisional patent application claiming priority to European Patent Application No. 24160890.0, filed Mar. 1, 2024, the contents of which are hereby incorporated by reference.

### TECHNICAL FIELD

The present disclosure relates to opto-mechanical sensing devices, especially for bio-sensing based on mechanical vibration.

### BACKGROUND

Generally, sensing a small vibration or motion can be useful in a variety of applications. It can also be used to characterize any biological system that may have a signature motion. Moreover, a fabrication technique to facilitate highly sensitive nano-motion sensors can be extremely useful for various fields. One such application may be to screen a drug or antibody. In this regard, the sensor can be used to detect a change in the living body in terms of a change in vibration due to the application of the drug or antibody. In some approaches, a cantilever arrangement with a micro-channel may be provided to translate the mass changes of the fluid traversing through the channel into changes in resonance frequency. However, the change in the vibration of the cantilever may be affected by the flow of the fluid through the channel formed in the cantilever.

### SUMMARY

To address these and other issues, this disclosure provides a micro-optomechanical sensor and a fabrication method thereof for facilitating an improved bio-sensing scheme based on mechanical vibration, which is also suitable for massive parallelization.

In the disclosure, a micro-optomechanical sensor is provided. The sensor comprises a surface comprising a cavity, and a fluidic channel on the surface connected to the cavity, wherein the fluidic channel is configured to transport a fluid sample to the cavity. The sensor further comprises a cantilever on the surface being laterally extended inside the cavity, wherein at least one side of the cantilever is configured to be in contact with the fluid sample inside the cavity.

Moreover, the sensor comprises an optical waveguide on the surface being extended to the cantilever, wherein the optical waveguide is configured to couple out a light signal from the cantilever in order to optically transduce a mechanical vibration of the cantilever.

Therefore, the cavity, especially the micro-cavity, may be used as a reservoir for the fluid sample and hence the vibration of the cantilever may not be affected by the flow of the fluid sample, which may improve the sensing accuracy. Moreover, by means of the integrated optical waveguide, a change in the vibration of the cantilever can be optically translated to identify an interaction or to map multiple interactions of the cantilever with the sample fluid within the cavity. For example, the fluid sample is a biological sample comprising at least one biological cell to be classified and/or identified.

In some embodiments, the at least one side of the cantilever comprises a coating of at least one antibody and/or at least one antigen and/or at least one protein and/or at least one aptamer corresponding to at least one biological cell in the fluid sample, e.g., the at least one biological cell of the biological sample.

In some embodiments, the mechanical vibration of the cantilever corresponds to a natural resonance frequency. In other embodiments, the mechanical vibration of the cantilever corresponds to a resonance frequency higher or lower than the natural resonance frequency due to an interaction of the at least one biological cell with the coating. In this way, cell-specific signatures can be effectively identified and/or classified by detecting the changes in the resonance frequency.

In some embodiments, the surface further comprises an inlet connected to the fluidic channel, wherein the inlet is configured to receive the fluid sample and further to transport the fluid sample to the fluidic channel.

In some embodiments, the cantilever is arranged on the surface in a non-overlapping manner with respect to the fluidic channel on the surface. Additionally or alternatively, the cantilever is arranged on the surface in a non-overlapping manner with respect to the inlet on the surface. In other embodiments, the cantilever is arranged on the surface in a non-overlapping manner with respect to both the inlet and the fluidic channel on the surface. In this way, the flow of the fluid sample may not be affected by the motion or vibration of the cantilever, which may further improve the sensing accuracy.

In some embodiments, the optical waveguide is a dielectric waveguide, such as a silicon-based waveguide. In this way, a low transmission loss and a good light confinement can be achieved, especially for the light traversing along the surface as well as along the cantilever.

In some embodiments, the surface is a processed silicon-on-insulator, SOI, wafer. In this way, a high yield can be achieved, especially for realizing a large number of parallel sensors in a highly dense manner.

According to a second aspect of the disclosure, a sensor system is provided. The sensor system comprises at least one micro-optomechanical sensor such as that described above. The sensor system further comprises at least one light source optically coupled to the optical waveguide of the at least one micro-optomechanical sensor, the optical waveguides of the respective plurality of micro-optomechanical sensors, wherein the at least one light source is configured to generate the light signal for the optical waveguide of the at least one micro-optomechanical sensor, for each of the optical waveguides of the respective plurality of micro-optomechanical sensors.

Moreover, the sensor system comprises a processing device, especially arranged in relation to the cantilever of the at least one micro-optomechanical sensor, to the cantilevers of the respective plurality of micro-optomechanical sensors, the processing device being optically coupled to the at least one micro-optomechanical sensor, to the plurality of micro-optomechanical sensors, wherein the processing device is configured to receive the light signal coupled out from the optical waveguide of the at least one micro-optomechanical sensor, from each of the optical waveguides of the respective plurality of micro-optomechanical sensors, and further to optically transduce the mechanical vibration of the cantilever of the at least one micro-optomechanical sensor, the mechanical vibration of the cantilevers of the respective plurality of micro-optomechanical sensors.

In this regard, for the at least one micro-optomechanical sensor, for each of the plurality of the micro-optomechanical sensors, the processing device is further configured to process the light signal coupled out from the optical waveguide to detect a change in the resonance frequency of the mechanical vibration of the cantilever due to the interaction of the at least one biological cell with the coating, and to classify and/or identify the at least one biological cell in the fluid sample based on the detected change in the resonance frequency.

In this way, the parallelization of the micro-optomechanical sensors can be achieved, which may reduce the screening time, e.g., to classify and/or identify one or more cell-specific signatures simultaneously or sequentially.

In the disclosure, a method is provided for fabricating a micro-optomechanical sensor on a SOI wafer comprising a dielectric layer in between a top silicon layer and a bottom silicon layer. The method comprises a step of defining a length of a cantilever and a length of a cavity on the SOI wafer. In addition, the method comprises a step of processing an optical waveguide on the top silicon layer, the optical waveguide being extended over the length of the cantilever.

Furthermore, the method comprises a step of processing a first etched groove at an edge of the length of the cantilever within the length of the cavity by etching the top silicon wafer, the dielectric layer, and partially the bottom silicon layer from the top silicon layer side.

In addition, the method comprises a step of processing a second etched groove corresponding to the length of the cavity by etching the bottom silicon layer and the dielectric layer from the bottom silicon layer side, thereby forming the cavity in the second silicon layer and the cantilever on the first silicon layer laterally extended inside the cavity.

The method further comprises a step of bonding a substrate on the bottom silicon layer at least encompassing the cavity from the bottom silicon layer side. Moreover, the method comprises a step of processing a fluidic channel on the top silicon layer from the top silicon layer side.

In this way, a miniaturization of the micro-optomechanical sensor can be achieved, which may reduce the cost and size, and may allow for massive parallelization.

In some embodiments, the processing of the optical waveguide comprises a step of forming optical waveguide components on the top silicon layer from the top silicon layer side. Alternatively, the processing of the optical waveguide comprises a step of bonding an additional layer on the top silicon layer and forming optical waveguide components on the additional layer from the top silicon layer side. In this way, the optical waveguide can be processed on the top silicon layer in a flexible manner based on, e.g., the thickness of the sensor, the wavelength of the light, and so on.

In some embodiments, the processing of the first etched groove and/or the processing of the second etched groove further comprise a step of using the dielectric layer in between the top silicon layer and the bottom silicon layer as a etch stop layer. In this way, the processing of the grooves can be effectively and accurately performed.

In some embodiments, the bonding of the substrate on the bottom silicon layer comprises a step of bonding the substrate on the bottom silicon layer via oxide fusion between the substrate and the bottom silicon layer. In some embodiments, the bonding of the substrate on the bottom silicon layer comprises a step of bonding the substrate on the bottom silicon layer via an adhesive layer in between the substrate and the bottom silicon layer. In some embodiments, for example, the cavity in the bottom silicon layer can be effectively sealed in a flexible manner.

In some embodiments, the processing of the fluidic channel comprises the steps of laminating a dry-film-resist, DFR, on the top silicon layer, patterning the fluidic channel via lithography on the DFR, and hard-baking the patterned DFR. In this way, the fluidic channel can be processed in a simplified manner, whereby additionally protecting the surface and its components by means of the laminated DFR.

In a first aspect, the disclosure describes a micro-optomechanical sensor. The micro-optomechanical sensor includes a surface comprising a cavity, and a fluidic channel on the surface connected to the cavity. The fluidic channel is configured to transport a fluid sample to the cavity. The micro-optomechanical sensor also includes a cantilever on the surface being laterally extended inside the cavity. At least one side of the cantilever is configured to be in contact with the fluid sample inside the cavity. The micro-optomechanical sensor also includes an optical waveguide on the surface being extended to the cantilever. The optical waveguide is configured to couple out a light signal from the cantilever in order to optically transduce a mechanical vibration of the cantilever.

In a second aspect, the disclosure describes a sensor system. The sensor system includes a at least one micro-optomechanical sensor in accordance with the first aspect. The sensor system also includes at least one light source optically coupled to the optical waveguide of the at least one micro-optomechanical sensor. The at least one light source is configured to generate the light signal for one or more optical waveguides of the at least one micro-optomechanical sensor. The sensor system also includes a processing device optically coupled to the at least one micro-optomechanical sensor. The processing device is configured to receive the light signal coupled out from each of the optical waveguides of the at least one micro-optomechanical sensor and further to optically transduce the mechanical vibration of one or more cantilevers of the at least one micro-optomechanical sensor.

In a third aspect, the disclosure describes a method for fabricating a micro-optomechanical sensor on a silicon-on-insulator (SOI) wafer comprising a dielectric layer in between a top silicon layer and a bottom silicon layer. The method includes defining a length of a cantilever and a length of a cavity on the SOI wafer. The method also includes processing an optical waveguide on the top silicon layer. The optical waveguide is extended over the length of the cantilever. The method also includes processing a first etched groove at an edge of the length of the cantilever within the length of the cavity by etching the top silicon layer, the dielectric layer, and partially the bottom silicon layer from the top silicon layer side. The method also includes processing a second etched groove corresponding to the length of the cavity by etching the bottom silicon layer and the dielectric layer from the bottom silicon layer side, thereby forming the cavity in the bottom silicon layer and the cantilever on the top silicon layer laterally extended inside the cavity. The method also includes bonding a substrate on the bottom silicon layer at least encompassing the cavity from the bottom silicon layer side. The method also includes processing a fluidic channel on the top silicon layer from the top silicon layer side.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 shows a micro-optomechanical sensor according to example embodiments.

FIG. 2 shows a sensor system according to an example embodiments.

FIG. 3A shows a silicon-on-insulator (SOI) wafer according to example embodiments.

FIG. 3B shows a process for forming an optical waveguide on the SOI wafer according to example embodiments.

FIG. 3C shows an alternative process for forming the optical waveguide on the SOI wafer according to example embodiments.

FIG. 4A shows a process for defining the in-plane geometry of the micro-optomechanical sensor according to example embodiments.

FIG. 4B shows an alternative process for defining the in-plane geometry of the micro-optomechanical sensor according to example embodiments.

FIG. 5A shows a process for forming the cavity and the cantilever according to example embodiments.

FIG. 5B shows an alternative process for forming the cavity and the cantilever according to example embodiments.

FIG. 6A shows a process for sealing the cavity according to example embodiments.

FIG. 6B shows an alternative process for sealing the cavity according to example embodiments.

FIG. 7A shows a process for forming the fluidic channel according to example embodiments.

FIG. 7B shows an alternative process for forming the fluidic channel according to example embodiments.

FIG. 8 shows an exemplary flow diagram of the method according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

It is important to note that, in the description as well as in the claims, the word “comprising” does not exclude other elements or steps and the indefinite article “a” or “an” does not exclude a plurality. A single element or other unit may fulfill the functions of several entities or items recited in the claims.

It should be understood that the term “and/or” used in the specification of this application refers to any combination and all possible combinations of one or more associated listed items, and includes these combinations.

It should also be understood that the word “connected” implies that the elements may be directly connected together or may be coupled through one or more intervening elements. Moreover, the disclosure with regard to any of the aspects is also relevant with regard to the other aspects of the disclosure.

Reference will now be made in detail to the embodiments of the present disclosure, examples of which are illustrated in the accompanying drawings. However, the following embodiments of the present disclosure may be variously modified and the range of the present disclosure is not limited by the following embodiments.

### I. Example Micro-Optomechanical Sensors

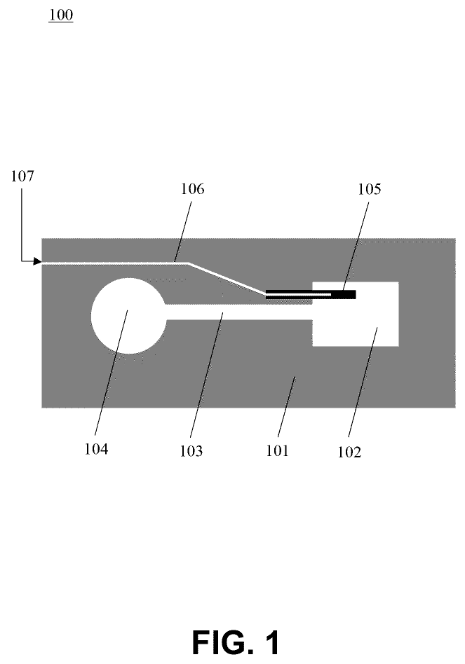

In FIG. 1, an example embodiment of the micro-optomechanical sensor 100 according to an aspect of the disclosure is illustrated. The sensor 100 may include a surface 101, which may itself include a micro-cavity or a cavity 102. The surface 101 may further include a micro-fluidic channel or a fluidic channel 103 connected to the cavity 102. Moreover, the surface 101 may include a micro-inlet or an inlet 104 connected to the fluidic channel 103.

In this regard, the inlet 104 may receive a biological sample fluid or a fluid sample and may transport the fluid sample to the fluidic channel 103, where the fluidic channel 103 may further transport the fluid sample to the cavity 102, which may act as a reservoir for the fluid sample.

In addition, the surface 101 may include a micro-cantilever or a cantilever 105 being laterally extended inside the cavity 102 such that one side, e.g., the bottom side, of the cantilever 105 may be in contact with the fluid sample inside the cavity 102. Furthermore, the cantilever 105 may be arranged on the surface 101 such that the cantilever 105 may not overlap with the inlet 104 as well as the fluidic sample 103.

In this regard, the bottom side of the cantilever 105 may be coated, e.g., the area or the portion of the bottom side of the cantilever 105 being in contact with the fluid sample, with one or more antibodies, or with one or more antigens, or with one or more proteins, or with one or more aptamers, or any combination thereof. Accordingly, the natural resonance frequency of the vibration of the cantilever 105 may be changed due to the interactions of the biological cells in the fluid sample with the coating.

The surface 101 may also include a micro-optical waveguide or an optical waveguide 106. The optical waveguide 106 may include an input port 107 for receiving or coupling-in a light signal, e.g., from an external or an internal light source (not shown). The optical waveguide 106 may be extended to the cantilever 105, for example, to the top side of the cantilever 105 opposite to the coated area of the cantilever 105.

For example, especially at the top side of the cantilever 105, the optical

waveguide 106 may comprise an output port (not shown) so that the optical waveguide 106 may couple out the light signal from the top side of the cantilever 105 via the output port in order to optically translate the mechanical vibration of the cantilever 105.

### II. Example Sensor Systems

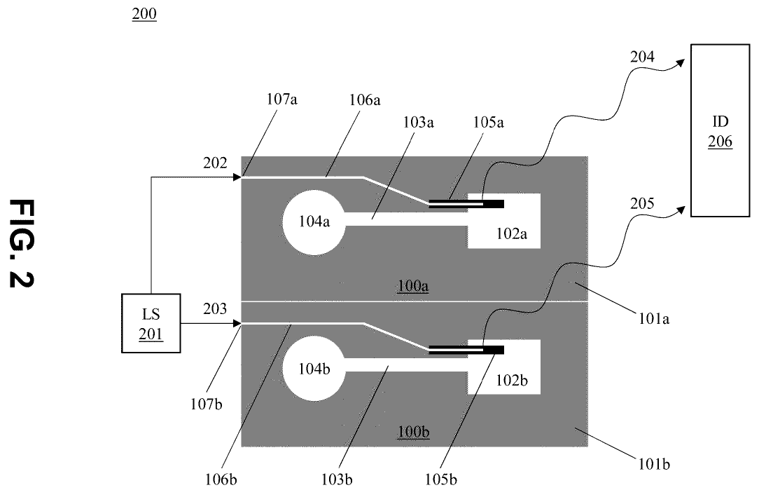

In FIG. 2, an example embodiment of the sensor system 200 according to an aspect of the disclosure is illustrated. The sensor system 200 may include a first micro-optomechanical sensor 100a and a second micro-optomechanical sensor 100b being operated in parallel. However, in some embodiments, the sensor system 200 may include more than two micro-optomechanical sensors 100a, 100b that can be operated in parallel.

For example, the first sensor 100a may correspond to the micro-optomechanical sensor 100 of FIG. 1. In this regard, the surface 101a, the cavity 102a, the fluidic channel 103a, the inlet 104a, the cantilever 105a, the optical waveguide 106a, and the light input port 107a may correspond to the surface 101, the cavity 102, the fluidic channel 103, the inlet 104, the cantilever 105, the optical waveguide 106, and the light input port 107 of the micro-optomechanical sensor 100, respectively.

The second sensor 100b may also correspond to the micro-optomechanical sensor 100 of FIG. 1. In this regard, the surface 101b, the cavity 102b, the fluidic channel 103b, the inlet 104b, the cantilever 105b, the optical waveguide 106b, and the light input port 107b may correspond to the surface 101, the cavity 102, the fluidic channel 103, the inlet 104, the cantilever 105, the optical waveguide 106, and the light input port 107 of the micro-optomechanical sensor 100, respectively.

In some embodiments, the fluid sample of the first sensor 100a and the fluid sample of the second sensor 100b may be different fluid samples, e.g., containing different types of biological cells. Alternatively, the fluid sample of the first sensor 100a and the fluid sample of the second sensor 100b may be similar fluid samples, e.g., containing similar types of biological cells.

In some embodiments, the coating of the cantilever 105a of the first sensor 100a and the coating of the cantilever 105b of the second sensor 100b may be different coatings, e.g., containing different types of antibodies and/or antigens and/or proteins and/or aptamers. Alternatively, the coating of the cantilever 105a of the first sensor 100a and the coating of the cantilever 105b of the second sensor 100b may be similar coatings, e.g., containing similar types of antibodies and/or antigens and/or proteins and/or aptamers.

The sensor system 200 may further include a light source 201, e.g., a laser light source such as a laser diode. The light source 200 may be optically connected to the light input port 107a of the first sensor 100a via a first optical path 202 such that the light source 201 may provide a first light signal 204 for the optical waveguide 106a of the first sensor 100a via the first optical path 202.

In addition, the light source 200 may be optically connected to the light input port 107b of the second sensor 100b via a second optical path 203 such that the light source 201 may provide a second light signal 205 for the optical waveguide 106b of the second sensor 100b via the second optical path 203.

In some embodiments, the first light signal 204 and the second light signal 205 may be light signals with similar electrical and/or optical characteristics, e.g., comprising identical or similar wavelengths. Alternatively, the first light signal 204 and the second light signal 205 may be light signals with different electrical and/or optical characteristics, e.g., comprising different wavelengths.

In this regard, the first optical path 202 and/or the second optical path 203 may include different electrical and/or optical modulation circuitry to provide light signals with different characteristics, e.g., wavelengths. Additionally or alternatively, the optical waveguide 106a of the first sensor 100a and/or the optical waveguide 106b of the second sensor 106b may include different electrical and/or optical modulation circuitry to provide light signals with different characteristics, e.g., wavelengths.

In some embodiments, the sensor system 200 may include a processing device 206 that is optically coupled to one or more sensors 100a, 100b. It may be noted that the term “optically coupled” is referred to herein as communicating optical signals with or without waveguide/optical fiber from the sensors 100a, 100b to the processing device 206. In some embodiments, the processing device 206 may include one or more light detectors configured to receive the light signals 204, 205. Additionally, the processing device 206 may include an imager or an imaging unit. The processing device 206 may be arranged in relation to the cantilever 105a of the first sensor 100a and the cantilever 105b of the second sensor 100b such that the processing device 206 may receive, especially in parallel, the first light signal 204 from the output port of the optical waveguide 106a at the top side of the cantilever 105a of the first sensor 100a and the second light signal 205 from the output port of the optical waveguide 106b at the top side of the cantilever 105b of the second sensor 100b.

In this regard, the processing device 206 may process the first light signal 204 and may detect a change in the resonance frequency of the mechanical vibration of the cantilever 105a of the first sensor 100a, e.g., due to the interaction of the first fluid sample with the coating, and may classify and/or identify one or more cells or the signature of the cells of the first fluid sample based on the detected change in the resonance frequency.

Similarly, the processing device 206 may process the second light signal 205 and may detect a change in the resonance frequency of the mechanical vibration of the cantilever 105b of the second sensor 100b, e.g., due to the interaction of the second fluid sample with the coating, and may classify and/or identify one or more cells or the signature of the cells of the second fluid sample based on the detected change in the resonance frequency.

### III. Example Processes

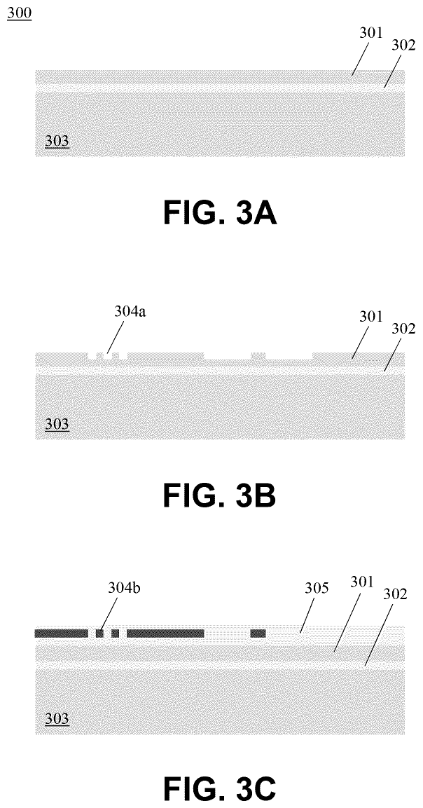

In FIG. 3A, an example SOI wafer 300 according to an aspect of the disclosure is illustrated. The SOI wafer 300 may include a top silicon layer 301, a bottom silicon layer 303, and a dielectric layer 302, e.g., an oxide-based dielectric such as SiO₂, in-between the top silicon layer 301 and the bottom silicon layer 303.

In some embodiments, the bottom silicon layer 303 (or the “SOI substrate”) may have a thickness of about 1 micrometer to 300 micrometers. The dielectric layer 302 (or the “buried oxide layer”) may have a thickness of about 2 micrometers to 20 micrometers. The top silicon layer 301 (or the “device layer”) may have a thickness of about 1 micrometer to 30 micrometers.

In FIG. 3B, an example process for forming the optical waveguide 304a on the SOI wafer 300 according to an aspect of the disclosure is illustrated. For example, a length of the cantilever may be defined on the top silicon layer 301. Afterwards, the optical waveguide 304a may be processed on the top silicon layer 301 from the top silicon layer side (front-end processing) such that the optical waveguide 304a may extend along the defined length of the cantilever. In this regard, the top silicon layer 301 may be patterned to make the waveguide components in a suitable manner during the front-end processing.

In FIG. 3C, an example process for forming the optical waveguide 304b on the SOI wafer 300 according to an aspect of the disclosure is illustrated. For example, an additional dielectric layer 305 may be added on the top silicon layer 301, e.g., via fusion or dielectric bonding. Afterwards, the length of the cantilever may be defined on the additional layer 305.

Furthermore, the optical waveguide 304b may be processed on the additional layer 305 from the top silicon layer side (front-end processing) such that the optical waveguide 304b may extend along the defined length of the cantilever. In this regard, the additional layer 305 may be patterned to make the waveguide components in a suitable manner during the front-end processing.

The additional layer 305 may have a thickness of about 1.5 micrometers. The optical waveguide 304b, especially the waveguide components, may be realized as planar waveguide components, e.g., SiN waveguide components.

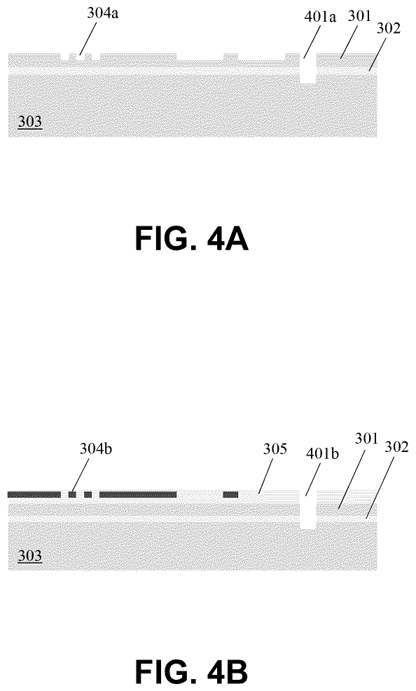

In FIG. 4A, an example process for defining the in-plane geometry of the micro-optomechanical sensor according to an aspect of the disclosure is illustrated. In this regard, a groove 401a may be formed in the front-end processing, especially at an edge of the defined length of the cantilever, by etching the top silicon layer 301, especially the processed top silicon layer as shown in FIG. 3A, the dielectric layer 302, and partially the bottom silicon layer 303.

In some embodiments, the dielectric layer 302 may be used as the stopping layer for the lithography and the subsequent etching to form the groove 401a. In this regard, the groove 401a may define the in-plane geometry of the sensor, especially of the cantilever of the sensor.

In FIG. 4B, another example process for defining the in-plane geometry of the micro-optomechanical sensor according to an aspect of the disclosure is illustrated. In this regard, a groove 401b may be formed in the front-end processing, especially at an edge of the defined length of the cantilever, by etching the additional layer 305, especially the processed additional layer as shown in FIG. 3B, the top silicon layer 301, the dielectric layer 302, and partially the bottom silicon layer 303.

In some embodiments, the dielectric layer 302 may be used as the stopping layer for the lithography and the subsequent etching to form the groove 401b. In this regard, the groove 401b may define the in-plane geometry of the sensor, especially of the cantilever of the sensor.

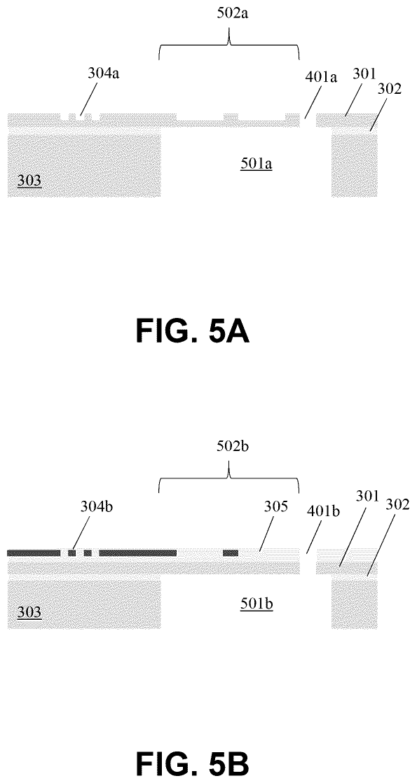

In FIG. 5A, an example process for forming a cavity and a cantilever according to an aspect of the disclosure is illustrated. As shown, a length of the cavity may be defined on the bottom silicon layer 303. Afterwards, a groove 501a may be formed from the bottom silicon layer side (back-end processing) by etching the bottom silicon layer 303 and the dielectric layer 302.

In some embodiments, the dielectric layer 302 may be used as the stopping layer for the lithography and the subsequent etching to form the groove 501a. In this regard, the groove 501a may define the in-plane geometry of the cavity and may further release the cantilever 502a with the optical waveguide 304a, especially by conjoining with the groove 401a.

In FIG. 5B, another example process for forming the cavity and the cantilever according to an aspect of the disclosure is illustrated. As shown, the length of the cavity may be defined on the bottom silicon layer 303. Afterwards, a groove 501b may be formed from the bottom silicon layer side (back-end processing) by etching the bottom silicon layer 303 and the dielectric layer 302.

In some embodiments, the dielectric layer 302 may be used as the stopping layer for the lithography and the subsequent etching to form the groove 501b. In this regard, the groove 501b may define the in-plane geometry of the cavity and may further release the cantilever 502b with the additional layer 305 comprising the optical waveguide 304b, especially by conjoining with the groove 401b.

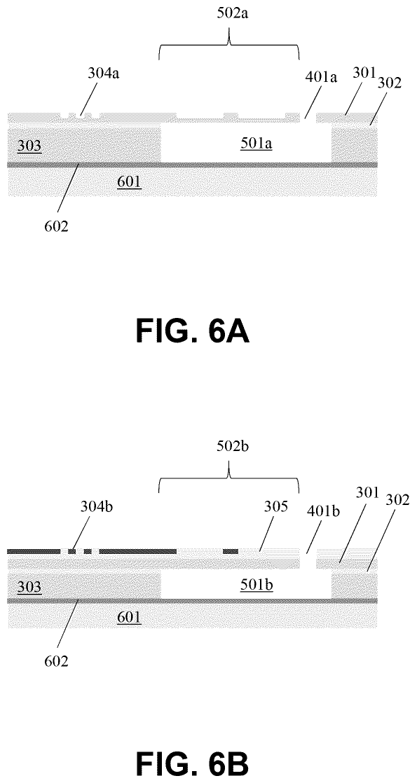

In FIG. 6A, an example process for sealing the cavity according to an aspect of the disclosure is illustrated. As shown, a substrate 601 may be bonded to the bottom silicon layer 303, for instance to the processed bottom silicon layer as shown in FIG. 5A, in the back-end processing such that the substrate 601 may encompass at least the groove 501a. As such, the substrate 601 may completely seal the groove 501a to form the cavity in the bottom silicon layer 303.

Accordingly, the sealing of the groove 501a may result in the cavity in the bottom silicon layer 303, which may surround the cantilever 502a realized on the first silicon layer 301 with the optical waveguide 304a.

In FIG. 6B, another example process for sealing the cavity according to an aspect of the disclosure is illustrated. For example, the substrate 601 may be bonded to the bottom silicon layer 303, for instance to the processed bottom silicon layer as shown in FIG. 5B, in the back-end processing such that the substrate 601 may encompass at least the groove 501b. As such, the substrate 601 may completely seal the groove 501b to form the cavity in the bottom silicon layer 303.

Accordingly, the sealing of the groove 501b may result in the cavity in the bottom silicon layer 303, which may surround the cantilever 502b realized on the first silicon layer 301 with the additional layer 305 comprising the optical waveguide 304b.

Regarding the substrate 601 of FIGS. 6A and 6B, the substrate 601 may be a silicon substrate or a glass substrate in some embodiments. For instance, the substrate 601 may be bonded to the bottom silicon layer 303 via oxide fusion between the substrate 601 and the bottom silicon layer 303. Alternatively, the substrate 601 may be bonded to the bottom silicon layer 303 via an adhesive layer 602 in between the substrate 601 and the bottom silicon layer 303. The adhesive layer 602 may be a layer of polyimide-based adhesives or a layer of acrylic-based adhesives.

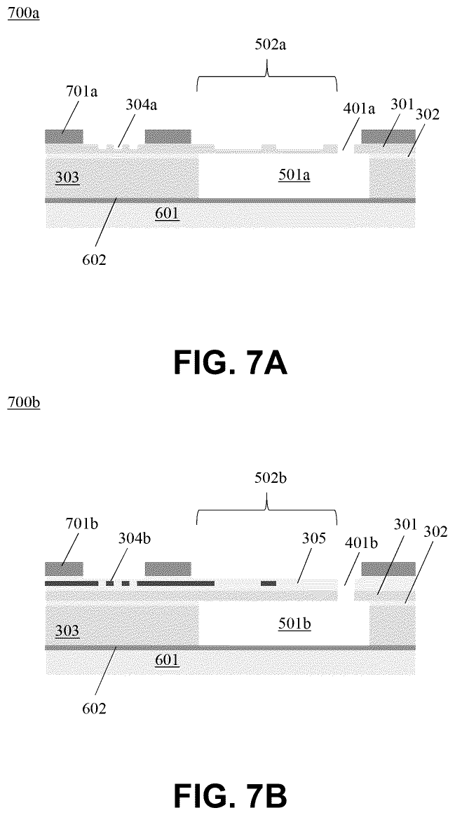

In FIG. 7A, an example process for forming the fluidic channel 701a according to an aspect of the disclosure is illustrated. For example, the fluidic channel 701a may be formed on the top silicon layer 301, for instance on the processed top silicon layer comprising the cantilever 502a with the optical waveguide 304a, in the front-end processing.

In some embodiments, the fluidic channel 701a may be formed in the front-end processing by laminating a dry-film-resist (DFR) on the processed top silicon layer comprising the cantilever 502a with the optical waveguide 304a. Afterwards, the DFR may be patterned via lithography such that a fluidic connection with the cavity can be formed, and the patterned DFR may be subsequently hard-baked in order to fix the patterns. This may result in the micro-optomechanical sensor 700a.

It is to be noted that the fluidic channel 701a may be alternatively processed after the process for defining the in-plane geometry of the micro-optomechanical sensor, especially after the processing of the groove 401a to define the in-plane geometry of the cantilever, as shown in FIG. 4A above.

In FIG. 7B, another example process for forming the fluidic channel 701b according to an aspect of the disclosure is illustrated. For example, the fluidic channel 701b may be formed on the additional layer 305, for instance on the processed additional layer comprising the optical waveguide 304b, in the front-end processing.

In some embodiments, the fluidic channel 701b may be formed in the front-end processing by laminating a dry-film-resist (DFR) on the processed additional layer comprising the optical waveguide 304b. Afterwards, the DFR may be patterned via lithography such that a fluidic connection with the cavity can be formed, and the patterned DFR may be subsequently hard-baked in order to fix the patterns. This may result in the micro-optomechanical sensor 700b.

It is to be noted that the fluidic channel 701b may be alternatively processed after the process for defining the in-plane geometry of the micro-optomechanical sensor, especially after the processing of the groove 401b to define the in-plane geometry of the cantilever, as shown in FIG. 4B above.

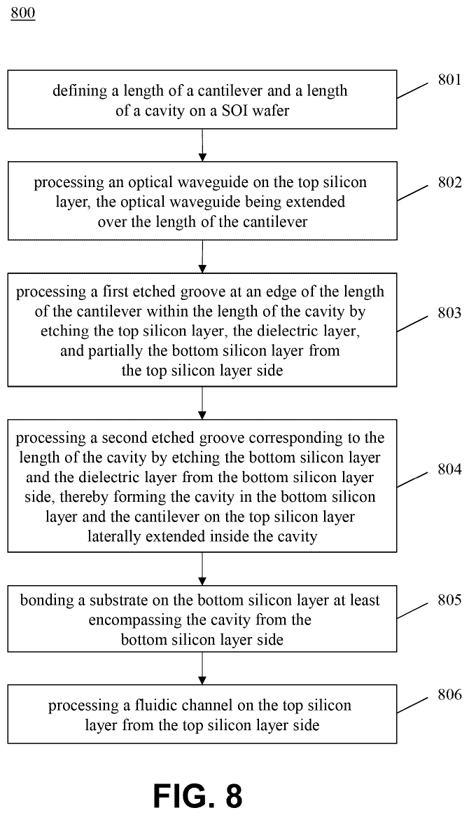

In FIG. 8, an exemplary flow diagram of the method 800 according to the third aspect of the invention is illustrated. In a first step 801, a length of a cantilever and a length of a cavity are defined on a SOI wafer comprising a dielectric layer in between a top silicon layer and a bottom silicon layer. In a second step 802, an optical waveguide is processed on the top silicon layer such that the optical waveguide extends over the length of the cantilever.

In a third step 803, a first etched groove is processed at an edge of the length of the cantilever within the length of the cavity by etching the top silicon wafer, the dielectric layer, and partially the bottom silicon layer from the top silicon layer side.

In a fourth step 804, a second etched groove corresponding to the length of the cavity is processed by etching the bottom silicon layer and the dielectric layer from the bottom silicon layer side in order to form the cavity in the second silicon layer and the cantilever on the first silicon layer laterally extended inside the cavity.

In a fifth step 805, a substrate is bonded on the bottom silicon layer in order to encompass at least the cavity from the bottom silicon layer side. In a sixth step 806, a fluidic channel on the top silicon layer is processed from the top silicon layer side.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

### IV. Enumerated Example Embodiments

Embodiments of the present disclosure may thus relate to one of the enumerated example embodiments (EEEs) listed below.

EEE 1 is a micro-optomechanical sensor comprising:
a surface comprising a cavity;
a fluidic channel on the surface connected to the cavity, wherein the fluidic channel is configured to transport a fluid sample to the cavity;
a cantilever on the surface being laterally extended inside the cavity, wherein at least one side of the cantilever is configured to be in contact with the fluid sample inside the cavity; and
an optical waveguide on the surface being extended to the cantilever, wherein the optical waveguide is configured to couple out a light signal from the cantilever in order to optically transduce a mechanical vibration of the cantilever.

EEE 2 is the micro-optomechanical sensor according to EEE 1, wherein the at least one side of the cantilever comprises a coating of at least one antibody and/or at least one antigen and/or at least one protein and/or at least one aptamer, corresponding to at least one biological cell in the fluid sample.

EEE 3 is the micro-optomechanical sensor according to EEE 2, wherein the mechanical vibration of the cantilever corresponds to a natural resonance frequency.

EEE 4 is the micro-optomechanical sensor according to EEE 2, wherein the mechanical vibration of the cantilever corresponds to a resonance frequency higher or lower than the natural resonance frequency due to an interaction of the at least one biological cell with the coating.

EEE 5 is the micro-optomechanical sensor according to EEE 1, wherein the surface further comprises an inlet connected to the fluidic channel, wherein the inlet is configured to receive the fluid sample and further to transport the fluid sample to the fluidic channel.

EEE 6 is the micro-optomechanical sensor according to EEE 1, wherein the cantilever is arranged on the surface in a non-overlapping manner with respect to the fluidic channel on the surface.

EEE 7 is the micro-optomechanical sensor according to EEE 1, wherein the

optical waveguide is a dielectric waveguide.

EEE 8 is the micro-optomechanical sensor according to EEE 7, wherein the dielectric waveguide is a silicon-based waveguide.

EEE 9 is the micro-optomechanical sensor according to EEE 1, wherein the surface is a processed silicon-on-insulator (SOI) wafer.

EEE 10 is a sensor system comprising:
at least one micro-optomechanical sensor comprising:
   a surface comprising a cavity,
   a fluidic channel on the surface connected to the cavity, wherein the fluidic channel is configured to transport a fluid sample to the cavity,
   a cantilever on the surface being laterally extended inside the cavity, wherein at least one side of the cantilever is configured to be in contact with the fluid sample inside the cavity, and
   an optical waveguide on the surface being extended to the cantilever, wherein the optical waveguide is configured to couple out a light signal from the cantilever in order to optically transduce a mechanical vibration of the cantilever;
at least one light source optically coupled to the optical waveguide of the at least one micro-optomechanical sensor, wherein the at least one light source is configured to generate the light signal for one or more optical waveguides of the at least one micro-optomechanical sensor; and
a processing device optically coupled to the at least one micro-optomechanical sensor, wherein the processing device is configured to receive the light signal coupled out from each of the optical waveguides of the at least one micro-optomechanical sensor and further to optically transduce the mechanical vibration of one or more cantilevers of the at least one micro-optomechanical sensor.

EEE 11 is the sensor system of EEE 10, wherein the at least one side of the cantilever comprises a coating of at least one antibody and/or at least one antigen and/or at least one protein and/or at least one aptamer, corresponding to at least one biological cell in the fluid sample.

EEE 12 is the sensor system according to EEE 11, wherein the processing device is further configured to:
process the light signal coupled out from the optical waveguide to detect a change in the resonance frequency of the mechanical vibration of the cantilever due to the interaction of the at least one biological cell with the coating, and
identify at least one biological cell in the fluid sample based on the detected change in the resonance frequency.

EEE 13 is a method for fabricating a micro-optomechanical sensor on a silicon-on-insulator (SOI) wafer comprising a dielectric layer in between a top silicon layer and a bottom silicon layer, the method comprising:
defining a length of a cantilever and a length of a cavity on the SOI wafer;
processing an optical waveguide on the top silicon layer, wherein the optical waveguide is extended over the length of the cantilever;
processing a first etched groove at an edge of the length of the cantilever within the length of the cavity by etching the top silicon layer, the dielectric layer, and partially the bottom silicon layer from the top silicon layer side;
processing a second etched groove corresponding to the length of the cavity by etching the bottom silicon layer and the dielectric layer from the bottom silicon layer side, thereby forming the cavity in the bottom silicon layer and the cantilever on the top silicon layer laterally extended inside the cavity;
bonding a substrate on the bottom silicon layer at least encompassing the cavity from the bottom silicon layer side; and
processing a fluidic channel on the top silicon layer from the top silicon layer side.

EEE 14 is the method according to EEE 13, wherein the processing of the optical waveguide comprises:
forming optical waveguide components on the top silicon layer from the top silicon layer side.

EEE 15 is the method according to EEE 13, wherein the processing of the optical waveguide comprises:
bonding an additional layer on the top silicon layer and forming optical waveguide components on the additional layer from the top silicon layer side.

EEE 16 is the method according to EEE 13, wherein the processing of the first etched groove further comprises using the dielectric layer in between the top silicon layer and the bottom silicon layer as a etch stop layer.

EEE 17 is the method according to EEE 13, wherein the processing of the second etched groove further comprises using the dielectric layer in between the top silicon layer and the bottom silicon layer as a etch stop layer.

EEE 18 is the method according to EEE 13,

wherein the bonding of the substrate on the bottom silicon layer comprises: bonding the substrate on the bottom silicon layer via oxide fusion between the substrate and the bottom silicon layer.

EEE 19 is the method according to EEE 13, wherein the bonding of the substrate on the bottom silicon layer comprises bonding the substrate on the bottom silicon layer via an adhesive layer in between the substrate and the bottom silicon layer.

EEE 20 is the method according to EEE 13, wherein the processing of the fluidic channel comprises:
laminating a dry-film-resist (DFR) on the top silicon layer,
patterning the fluidic channel via lithography on the DFR, and
hard-baking the patterned DFR.

### V. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A micro-optomechanical sensor comprising:
a surface comprising a cavity;
a fluidic channel on the surface connected to the cavity, wherein the fluidic channel is configured to transport a fluid sample to the cavity;
a cantilever on the surface being laterally extended inside the cavity, wherein at least one side of the cantilever is configured to be in contact with the fluid sample inside the cavity; and
an optical waveguide on the surface being extended to the cantilever, wherein the optical waveguide is configured to couple out a light signal from the cantilever in order to optically transduce a mechanical vibration of the cantilever.

2. The micro-optomechanical sensor according to claim 1,
wherein the at least one side of the cantilever comprises a coating of at least one antibody and/or at least one antigen and/or at least one protein and/or at least one aptamer, corresponding to at least one biological cell in the fluid sample.

3. The micro-optomechanical sensor according to claim 2,
wherein the mechanical vibration of the cantilever corresponds to a natural resonance frequency.

4. The micro-optomechanical sensor according to claim 2,
wherein the mechanical vibration of the cantilever corresponds to a resonance frequency higher or lower than the natural resonance frequency due to an interaction of the at least one biological cell with the coating.

5. The micro-optomechanical sensor according to claim 1, wherein the surface further comprises an inlet connected to the fluidic channel, wherein the inlet is configured to receive the fluid sample and further to transport the fluid sample to the fluidic channel.

6. The micro-optomechanical sensor according to claim 1, wherein the cantilever is arranged on the surface in a non-overlapping manner with respect to the fluidic channel on the surface.

7. The micro-optomechanical sensor according to claim 1, wherein the optical waveguide is a dielectric waveguide.

8. The micro-optomechanical sensor according to claim 7, wherein the dielectric waveguide is a silicon-based waveguide.

9. The micro-optomechanical sensor according to claim 1, wherein the surface is a processed silicon-on-insulator (SOI) wafer.

10. A sensor system comprising:
at least one micro-optomechanical sensor comprising:
a surface comprising a cavity,
a fluidic channel on the surface connected to the cavity, wherein the fluidic channel is configured to transport a fluid sample to the cavity,
a cantilever on the surface being laterally extended inside the cavity, wherein at least one side of the cantilever is configured to be in contact with the fluid sample inside the cavity, and
an optical waveguide on the surface being extended to the cantilever, wherein the optical waveguide is configured to couple out a light signal from the cantilever in order to optically transduce a mechanical vibration of the cantilever;
at least one light source optically coupled to the optical waveguide of the at least one micro-optomechanical sensor, wherein the at least one light source is configured to generate the light signal for one or more optical waveguides of the at least one micro-optomechanical sensor; and
a processing device optically coupled to the at least one micro-optomechanical sensor, wherein the processing device is configured to receive the light signal coupled out from each of the optical waveguides of the at least one micro-optomechanical sensor and further to optically transduce the mechanical vibration of one or more cantilevers of the at least one micro-optomechanical sensor.

11. The sensor system of claim 10, wherein the at least one side of the cantilever comprises a coating of at least one antibody and/or at least one antigen and/or at least one protein and/or at least one aptamer, corresponding to at least one biological cell in the fluid sample.

12. The sensor system according to claim 11, wherein the processing device is further configured to:
process the light signal coupled out from the optical waveguide to detect a change in the resonance frequency of the mechanical vibration of the cantilever due to the interaction of the at least one biological cell with the coating, and
identify at least one biological cell in the fluid sample based on the detected change in the resonance frequency.

13. A method for fabricating a micro-optomechanical sensor on a silicon-on-insulator (SOI) wafer comprising a dielectric layer in between a top silicon layer and a bottom silicon layer, the method comprising:
defining a length of a cantilever and a length of a cavity on the SOI wafer;
processing an optical waveguide on the top silicon layer, wherein the optical waveguide is extended over the length of the cantilever;
processing a first etched groove at an edge of the length of the cantilever within the length of the cavity by etching the top silicon layer, the dielectric layer, and partially the bottom silicon layer from the top silicon layer side;
processing a second etched groove corresponding to the length of the cavity by etching the bottom silicon layer and the dielectric layer from the bottom silicon layer side, thereby forming the cavity in the bottom silicon layer and the cantilever on the top silicon layer laterally extended inside the cavity;
bonding a substrate on the bottom silicon layer at least encompassing the cavity from the bottom silicon layer side; and
processing a fluidic channel on the top silicon layer from the top silicon layer side.

14. The method according to claim 13, wherein the processing of the optical waveguide comprises:
forming optical waveguide components on the top silicon layer from the top silicon layer side.

15. The method according to claim 13, wherein the processing of the optical waveguide comprises:
bonding an additional layer on the top silicon layer and forming optical waveguide components on the additional layer from the top silicon layer side.

16. The method according to claim 13, wherein the processing of the first etched groove further comprises using the dielectric layer in between the top silicon layer and the bottom silicon layer as a etch stop layer.

17. The method according to claim 13, wherein the processing of the second etched groove further comprises using the dielectric layer in between the top silicon layer and the bottom silicon layer as a etch stop layer.

18. The method according to claim 13,
wherein the bonding of the substrate on the bottom silicon layer comprises:
bonding the substrate on the bottom silicon layer via oxide fusion between the substrate and the bottom silicon layer.

19. The method according to claim 13, wherein the bonding of the substrate on the bottom silicon layer comprises bonding the substrate on the bottom silicon layer via an adhesive layer in between the substrate and the bottom silicon layer.

20. The method according to claim 13, wherein the processing of the fluidic channel comprises:
laminating a dry-film-resist (DFR) on the top silicon layer,
patterning the fluidic channel via lithography on the DFR, and
hard-baking the patterned DFR.
